(19) United States
(12) Patent Application Publication
(10) Pub. No.: US 2009/0232521 A1
(43) Pub. Date: Sep. 17, 2009

(54) IMAGE FORMING APPARATUS, METHOD OF CONTROLLING THE IMAGE FORMING APPARATUS, AND STORAGE MEDIUM

(75) Inventor: Ryotaro Imine, Machida-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/404,439

(22) Filed: Mar. 16, 2009

(30) Foreign Application Priority Data
Mar. 17, 2008 (JP) 2008-067881

(51) Int. Cl. G03G 15/00

(52) U.S. Cl. 399/16

(57) ABSTRACT

An image forming apparatus which enables even a user who is not well informed about the mechanism of the image forming apparatus to easily perform operation check on a component roller. The image forming apparatus is provided with a sheet conveying mechanism including a plurality of component rollers. A CPU of a controller of the image forming apparatus selects a component roller to be subjected to operation check from the component rollers. Then, the CPU determines a sheet conveying path to pass the selected component roller. Further, the CPU controls the sheet conveying mechanism such that a sheet is conveyed along the determined conveying path. The CPU detects the conveyance status of a sheet while the sheet is being conveyed along the conveying path.

### BACKGROUND OF THE INVENTION

1. Field of the Invention

The present invention relates to an image forming apparatus, such as a copying machine provided with a sheet conveying mechanism including a plurality of component rollers, a method of controlling the image forming apparatus, and a storage medium storing a control program for implementing the method.

2. Description of the Related Art

Conventionally, maintenance of a copying machine or the like apparatus for business use has been carried out by a service person dispatched e.g. to an office where the apparatus is installed.

The maintenance work includes replacement of component rollers as consumables provided in the apparatus, and after the replacement of the component rollers, the service person checks whether or not each new component roller is normally operating.

The check is generally achieved by configuring settings for enabling a new component roller to operate in the apparatus and then actually operating the component roller. The service person is well informed about a mechanism of the copying machine or the like for operating a new component roller after replacement, so that he/she can configure appropriate settings according to the new component roller and its location, based on his/her technical knowledge (see Japanese Patent Laid-Open Publication No. 2007-072118).

Now, it is desired that even an image forming apparatus, such as a copying machine, for business use is configured such that replacement of a component roller can be easily performed by a user him/herself as well.

However, not all general users are well informed, as all service persons are, about the mechanism of a copying machine or the like apparatus for operating a new component roller after replacement, and hence some users have difficulty in configuring appropriate settings for checking the operation of the new component roller.

For example, in the case of replacing a plurality of component rollers constituting a sheet conveying path e.g. in a copying machine, it is difficult to judge the relationship between settings of sheet feeders, an inverting path, etc. and the operations of the component rollers, for checking determining the operations of the component rollers.

### SUMMARY OF THE INVENTION

The present invention provides an image forming apparatus which enables even a user who is not well informed about the mechanism of the image forming apparatus to easily perform operation check on a component roller, a method of controlling the image forming apparatus, and a storage medium storing a control program for implementing the method.

In a first aspect of the present invention, there is provided an image forming apparatus provided with a sheet conveying mechanism including a plurality of component rollers, comprising a selecting unit configured to select a component roller to be subjected to operation check from the component rollers, a determining unit configured to determine a sheet conveying path passing the component roller selected by the selecting unit, and a control unit configured to control the sheet conveying mechanism such that a sheet is conveyed along the conveying path determined by the determining unit.

In a second aspect of the present invention, there is provided a method of controlling an image forming apparatus provided with a sheet conveying mechanism including a plurality of component rollers, comprising selecting a component roller to be subjected to operation check from the component rollers, determining a sheet conveying path to pass the selected component roller, and controlling the sheet conveying mechanism such that a sheet is conveyed along the determined conveying path.

In a third aspect of the present invention, there is provided a computer-readable storage medium storing a program for causing a computer to execute a method of controlling an image forming apparatus provided with a sheet conveying mechanism including a plurality of component rollers, wherein the method comprises selecting a component roller to be subjected to operation check from the component rollers, determining a sheet conveying path to pass the selected component roller, and controlling the sheet conveying mechanism such that a sheet is conveyed along the determined conveying path.

According to the present invention, a conveying path including a component roller targeted for operation check is automatically set. Therefore, it is possible for even a user who is not well informed about the mechanism of the image forming apparatus to easily perform the operation check on the component roller after replacement.

The features and advantages of the invention will become more apparent from the following detailed description taken in conjunction with the accompanying drawings.

### BRIEF DESCRIPTION OF THE DRAWINGS

FIG. 1 is a view of the appearance of an image forming apparatus according to an embodiment of the present invention.

FIG. 2 is a schematic cross-sectional view of the image forming apparatus in FIG. 1.

FIG. 3 is a block diagram of a controller.

FIG. 4 is a schematic view of the appearance of an operating section.

FIG. 5 is a schematic view of a liquid crystal operation panel with a standby screen in a normal copy operation mode displayed thereon.

FIG. 6 is a schematic view of the liquid crystal operation panel with a component replacement status screen displayed thereon.

FIG. 7 is a schematic view of the liquid crystal operation panel with an operation check job configuration screen displayed thereon.

FIG. 8 is a diagram of an example of a configuration table for use in configuring settings for component roller operation check.

FIG. 9 is a view of an example of a screen displaying results of component roller operation check.

FIG. 10 is a schematic cross-sectional view of the image forming apparatus, in which a conveying path determined for execution of operation check on component rollers is indicated by a dotted line.

FIG. 11 is a flowchart of an operation check process executed by the image forming apparatus according to the present embodiment.

FIG. 12 is a schematic cross-sectional view of the image forming apparatus, in which a conveying path determined for execution of operation check on different component rollers from the component rollers targeted in FIG. 10 is indicated by a dotted line.

### DETAILED DESCRIPTION OF THE EMBODIMENTS

The present invention will now be described in detail below with reference to the accompanying drawings showing embodiments thereof.

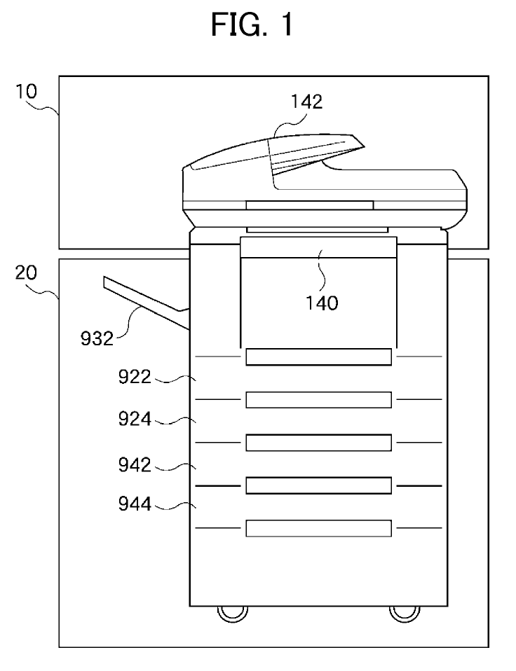

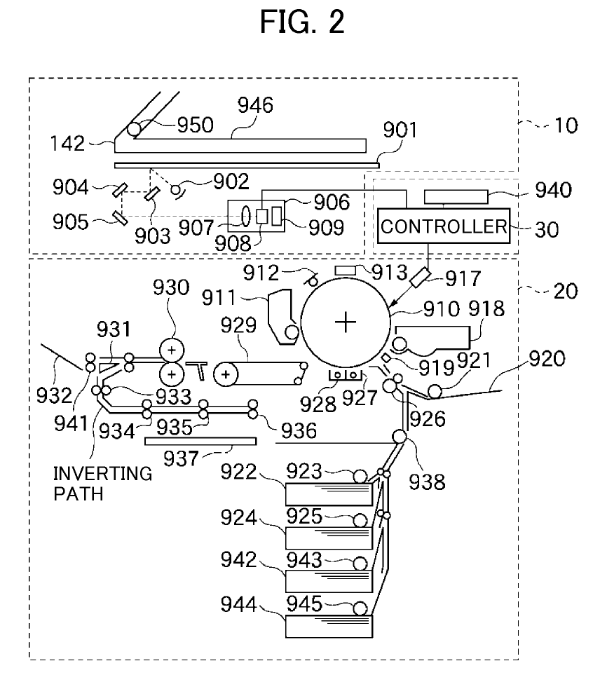

FIG. 1 is a view of the appearance of an image forming apparatus according to the embodiment of the present invention. FIG. 2 is a schematic cross-sectional view of the image forming apparatus in FIG. 1.

As shown in FIGS. 1 and 2, the image forming apparatus according to the present embodiment is comprised of a scanner section 10 and a printer section 20.

In the scanner section 10, when a user operates an operating section 140 to give an instruction for starting reading of images from originals, the originals fed from an automatic original feeder 142 by a sheet feed roller 950 are sequentially brought onto an original platen glass 901.

An original placed on the original platen glass 901 is irradiated with illuminating light emitted from an original illuminating lamp 902 implemented e.g. by a halogen lamp, and reflected light from the irradiated original is guided to an image pickup element unit 906 via scanning mirrors 903, 904, and 905 reciprocating in the sub scanning direction.

The image pickup element unit 906 is comprised of an image pickup element 908 implemented e.g. by a CCD, an imaging lens 907 through which the reflected light from the original is formed on the image pickup element 908, and a driver 909 for driving the image pickup element 908.

An image output signal from the image pickup element 908 is converted into e.g. 8-bit digital data, and then input to a controller 30. The controller 30 includes a microcomputer and an image processing section, and performs an image forming operation, described hereinafter, according to an instruction from a man machine interface device 940.

In the printer section 20, residual charge remaining on a photosensitive drum 910 is removed by a pre-exposure lamp 912 for an image forming operation, whereafter the surface of the photosensitive drum 910 is uniformly charged by a primary electrostatic charger 913. In this state, the photosensitive drum 910 is irradiated for exposure with a semiconductor laser beam from an exposure unit 917 based on image data processed by the controller 30, whereby an electrostatic latent image is formed on the surface of the photosensitive drum 910.

The electrostatic latent image is developed into a toner image by a development device 918. A high voltage is applied to the toner image developed on the photosensitive drum 910 by a pre-transfer charger 919 before the toner image is transferred onto a sheet.

On the other hand, a sheet fed from one of a manual feed tray 920 and sheet feeders 922, 924, 942, and 944 is conveyed into a conveying path by driving associated one of a conveying roller 921, and sheet feed rollers 923, 925, 943, and 945.

The sheet conveyed into the conveying path is once stopped at a registration roller 926, and is then conveyed through between the photosensitive drum 910 and a transfer charger 927 in timing synchronous with transfer of the toner image formed on the photosensitive drum 910.

Thus, the toner image formed on the photosensitive drum 910 is transferred onto the sheet, and the sheet having the toner image transferred thereon is separated from the photosensitive drum 910 by a separation charger 928. Further, residual toner remaining on the surface of the photosensitive drum 910 without being transferred onto the sheet is collected by a cleaner 911.

The sheet separated from the photosensitive drum 910 is conveyed to a fixing device 930 by a conveying belt 929, and the unfixed toner image on the sheet is fixed e.g. by heat. The sheet having passed through the fixing device 930 is selectively guided into a conveying passage to a discharge roller pair 941 or a conveying passage to an intermediate tray 937 by a switching operation of a flapper 931.

When the conveying passage to the intermediate tray 937 is selected, conveying roller pairs 933 to 936 convey the sheet to the intermediate tray 937 after inverting the same (for a multiple overlay printing) or without inverting the same (for double-sided printing). The sheet having conveyed to the intermediate tray 937 is conveyed to the registration roller 926 again by a refeed roller 938, and an image forming operation is perform in the same way as described above.

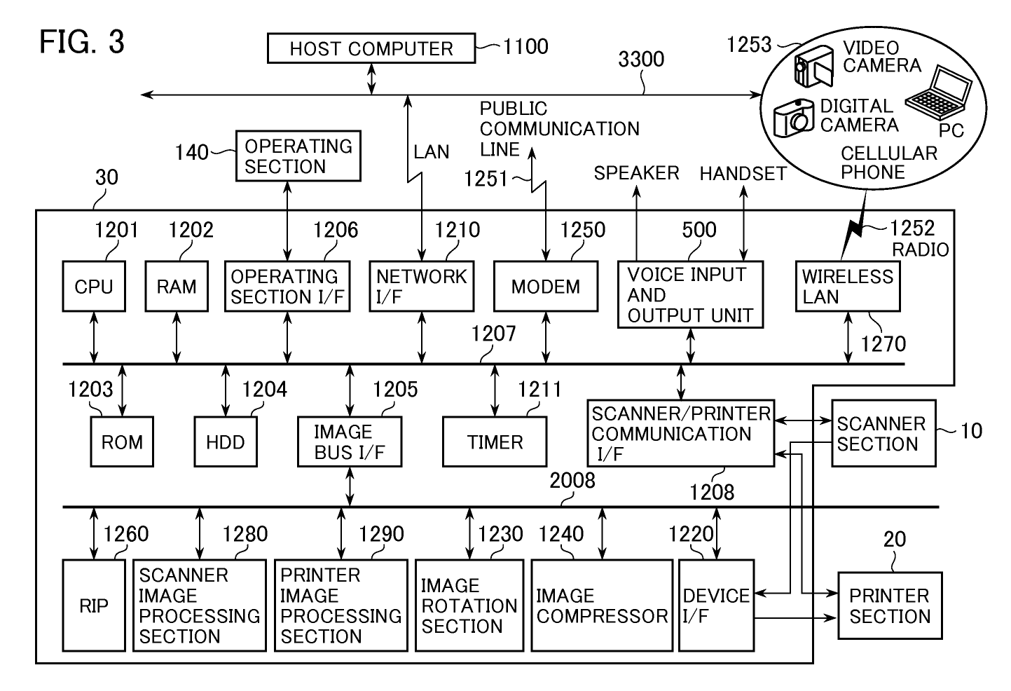

Next, the controller 30 will be described with reference to FIG. 3.

The controller 30 is connected to the scanner section 10 and the printer section 20, and includes a CPU 1201 for controlling the overall operation of the apparatus.

The CPU 1201 loads a control program stored in an HDD 1204 into a RAM 1202, and executes predetermined processes. The RAM 1202 is a system work memory used by the CPU 1202 for operation. The RAM 202 also temporarily stores image data. A ROM 1203 stores a system boot program. The HDD 1204 stores system software, application software, image data, and so forth.

An operating section interface 1206 provides interface with the operating section (UI: User Interface) 140, and outputs to the operating section 140 image data to be displayed on the same. The operating section interface 1206 also outputs information input by the user via the operating section 140 to the CPU 1201.

A network interface 1210 is connected to a LAN 3300, for input and output of various kinds of data concerning outputting images and information concerning apparatus control. Further, the network interface 1210 receives outputting image data from a host computer 1100 and an outputting image data management apparatus, not shown, on the network according to a user input operation performed via the operating section 140, and performs image output.

A modem 1250 is connected to a public communication line (WAN) 1251, for input and output of information. A voice input and output unit 500 performs control for outputting voice to a speaker, and outputting and inputting voice to a handset.

A wireless LAN 1270 is connected to peripheral apparatuses 1253, such as a digital camera and a PC, connected by a radio 1252, for input and output of various kinds of data concerning outputting images and information concerning apparatus control.

A scanner/printer communication interface 1208 provides interface for communication with a CPU, not shown, of each of the scanner section 10 and the printer section 20. Further, instructions for sheet conveyance control, which characterizes the present invention, for operation check on various kinds of rollers are issued via the scanner/printer communication interface 1208.

A timer 1211 functions to perform time setting for the image forming apparatus and the controller 30 and generate an interrupt at predetermined time intervals. The above-mentioned devices are arranged on a system bus 1207, and the system bus 1207 and an image bus 2008 for high-speed transfer of image data are interconnected by an image bus interface 1205 as a bus bridge for converting data structures.

The image bus 2008 is implemented by a PCI bus, an IEEE 1394 bus or the like. On the image bus 2008, there are arranged a RIP 1260, a device interface 1220, a scanner image processing section 1280, a printer image processing section 1290, an image rotation section 1230, and an image compressor 1240.

The RIP (Raster Image Processor) 1260 expands a PDL code into a bitmap image. The device interface 1220 connects the controller 30 to the scanner section 10, the printer section 20, etc. to perform synchronous-to-asynchronous or asynchronous-to-synchronous conversion of image data.

The scanner image processing section 1280 corrects, processes, and edits input image data. The printer image processing section 1290 performs correction, resolution conversion, etc. of image data to be printed out by the printer 20.

The image rotation section 1230 rotates image data. The image compressor 1240 compresses or expands multi-valued image data by JPEG, and binary image data by JBIG, MMR or MH.

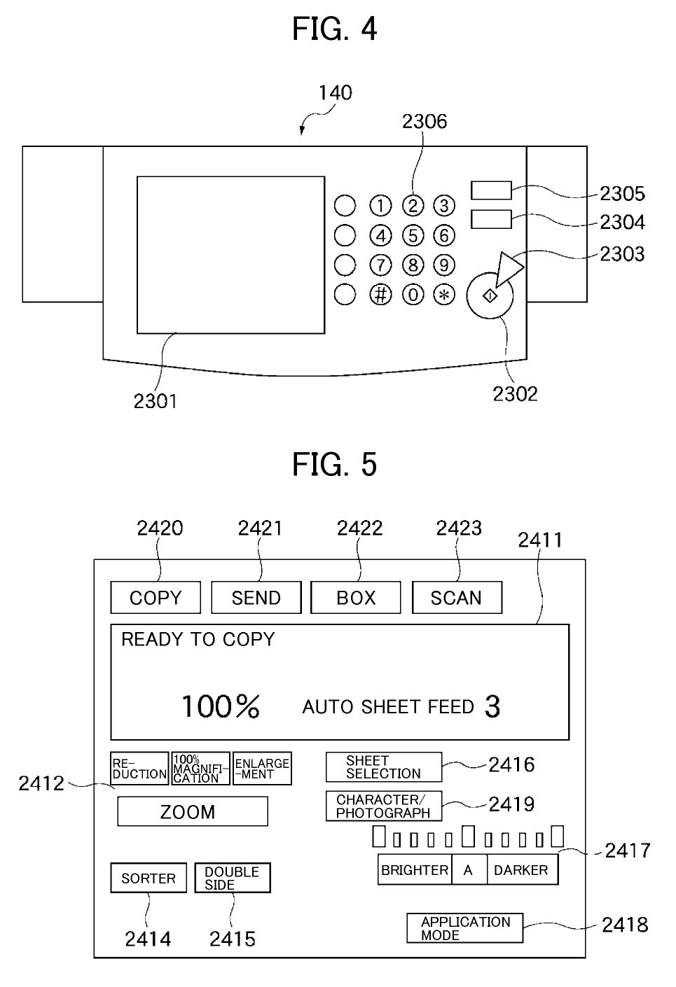

Next, the operating section 140 will be described with reference to FIG. 4.

As shown in FIG. 4, on the operating section 140, there are arranged a liquid crystal operation panel 2301, a start key 2302, a stop key 2303, ten keys 2306, a clear key 2305, a reset key 2304, and so forth.

The liquid crystal operation panel 2301 is formed e.g. by a combination of a liquid crystal panel and a touch panel. On the liquid crystal operation panel 2301 are displayed settings, soft keys, etc. The start key 2302 is a hard key used to give an instruction for starting a copy operation or the like. The start key 2302 incorporates green and red LEDs, and the green LED illuminates to indicate that it is possible to start, and the red LED illuminates to indicate that it is impossible to start.

The stop key 2303 is a hard key used to stop an operation. The ten keys 2306, the clear key 2305, and the reset key 2304 are also provided as a hard key group.

FIG. 5 shows the liquid crystal operation panel 2301 with a standby screen in a normal copy operation mode being displayed thereon. The standby screen shown in FIG. 5 is a standard screen displayed in a case where no rollers to be replaced are detected when the power of the image forming apparatus is turned on.

On the standby screen are arranged operating mode selection keys, i.e. a COPY key 2420, a SEND key 2421, a BOX key 2422, and a SCAN key 2423. When one of the operating mode selection keys is pressed, the standby screen is switched to a screen for a mode associated with the pressed key.

Further, on the standby screen are arranged a setting display section 2411, a zoom soft key group 2412, a sorter key 2414, a double-sided printing key 2415, a sheet selection key 2416, a density designation key group 2417, an application mode key 2418, and a character/photograph key 2419.

In the setting display section 2411 are displayed a current operation status of the image forming apparatus, a magnification, a sheet type, and the number of copies, which are currently set. The zoom soft key group 2412 is comprised of a 100% magnification key, an enlargement key, a reduction key, and a zoom key as soft keys concerning the magnification in copying.

The 100% magnification key is pressed to set the copy magnification to 100%. The reduction key and the enlargement key are pressed to perform fixed-ratio reduction and enlargement, respectively. The zoom key is pressed to perform unfixed-ratio reduction and enlargement in steps of 1%.

The sorter key 2414 is used to designate a method of processing printed sheets The double-sided printing key 2415 is used to designate double-sided printing for an original or an output method. The sheet selection key 2416 is used to perform transition to a screen for designating the size, color, material, etc. of printing sheets. In the present embodiment, sheet feed control is performed based on sheets selected using the sheet selection key 2416.

The density designation key group 2417 is used to adjust the density of a read image or a printed image. The application mode key 2418 is used to perform transition to an application mode screen.

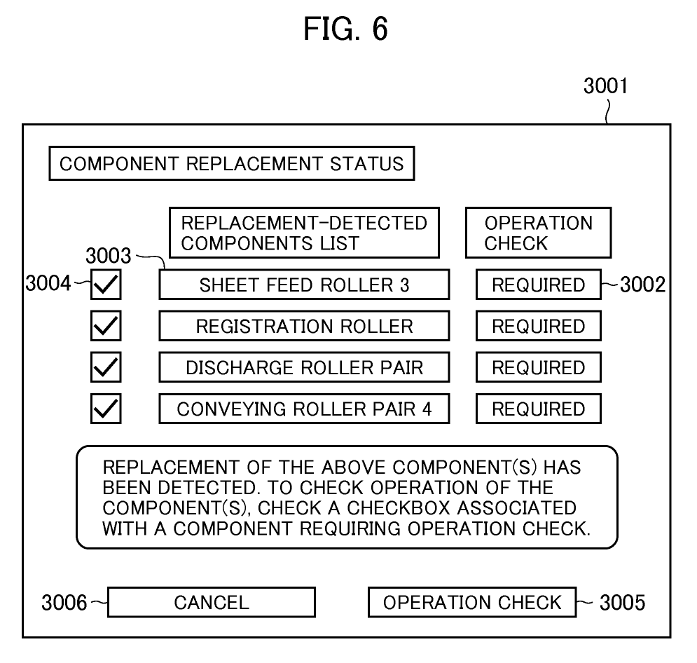

FIG. 6 shows the liquid crystal operation panel 2301 with a component replacement status screen 3001 displayed thereon. The component replacement status screen 3001 is displayed on the liquid crystal operation panel 2301 when roller replacement is detected upon power-on of the image forming apparatus.

On the component replacement status screen 3001 are arranged detected roller display boxes 3003 for displaying a list of rollers of which replacement has been detected, status display boxes 3002 each indicating whether or not operation check is required, and check boxes 3004 for selecting rollers to be subjected to operation check.

Further, on the component replacement status screen 3001 are arranged an operation check button 3005 used to give an instruction for execution of operation check and display an operation check job configuration screen, and a cancel button 3006 used to switch to a normal operation.

For selection of a component roller to be subjected to operation check, such a cross section of the apparatus as shown in FIG. 2 may be displayed on the component replacement status screen 3001 in FIG. 6 in place of the list of rollers of which replacement has been detected.

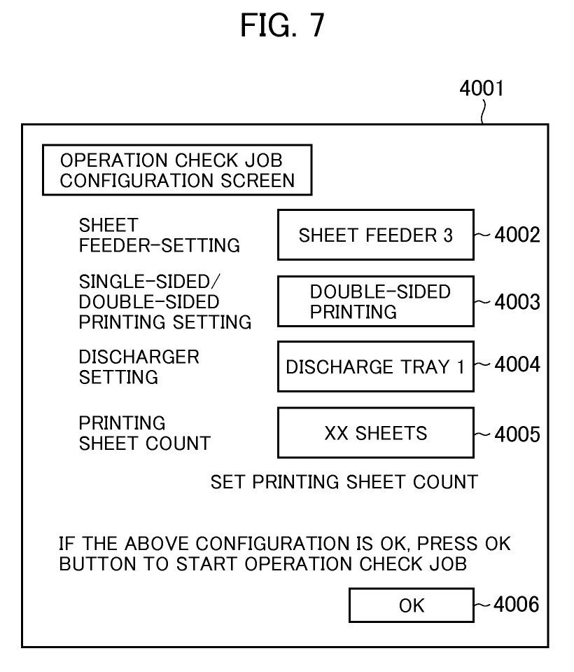

FIG. 7 shows the liquid crystal operation panel 2301 with an operation check job configuration screen 4001 displayed thereon.

The operation check job configuration screen 4001 is displayed when a roller whose operation is to be checked is selected by entering a check mark in an associated check box 3004 on the component replacement status screen 3001 and then the operation check button 3005 is pressed, for determining a conveying path including the selected roller.

On the operation check job configuration screen 4001, there are arranged a sheet feeder-setting display box 4002, a single-sided/double-sided printing-setting display box 4003, a discharger-setting display box 4004, and a printing sheet count display box 4005. Further, there is disposed an OK button 4006 used for giving an instruction for executing operation check based on settings configured using the boxes 4002, 4003, 4004, and 4005.

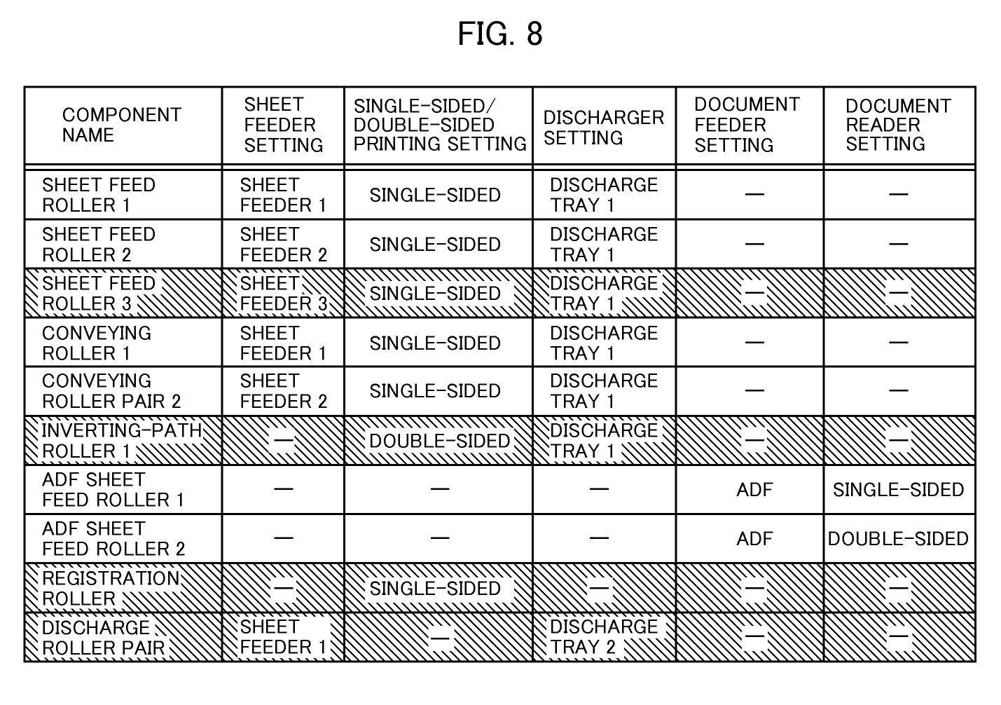

FIG. 8 shows an example of a configuration table for use in configuring settings for component roller operation check.

This configuration table determines in advance the relationship between each of the component rollers and a conveying path associated therewith. The configuration table is recorded and stored in a storage unit, such as the RAM 1202.

In the FIG. 8 example, boxes associated with component rollers selected for operation check by entering check marks in the respective checkboxes 3004 associated therewith in the FIG. 6 component replacement status screen 3001 are shown in a shaded manner.

For example, for a sheet feed roller 3, “sheet feeder 3” is designated by sheet feeder-setting, “single-sided” by single-sided/double-sided printing-setting, and “discharge tray 1” by discharger setting.

As described above, in executing operation check by conveying a sheet such that it passes each component roller selected in the component replacement status screen 3001, settings for operating the component roller are recorded and stored in the RAM 1202 in a tabulated form.

This table is shown only by way of example, and component rollers and settings associated therewith are by no means limited to examples shown in FIG. 8.

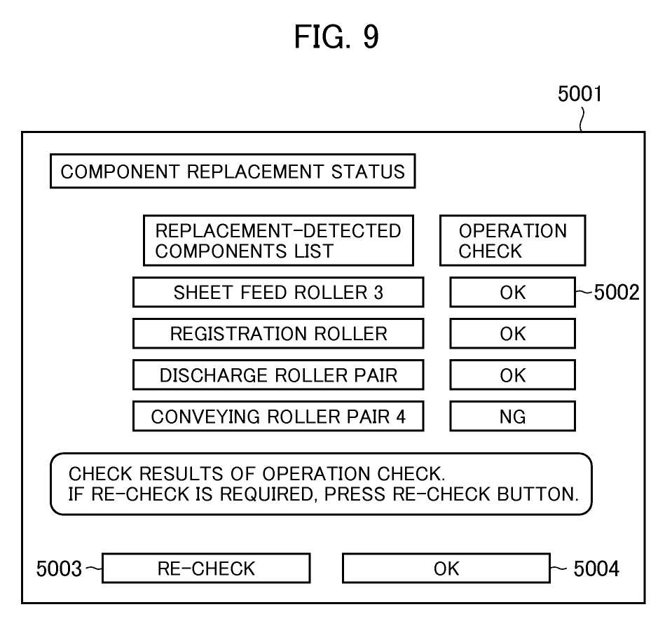

FIG. 9 shows an example of a screen displaying results of component roller operation check.

On an operation check result display screen 5001, which corresponds to the component replacement status screen 3001 in FIG. 6, the result of operation check performed on each of the selected component rollers is displayed as “OK” or “NG” in an associated operation check box 5002 (corresponding to the status display box 3002 in FIG. 6).

Further, on the operation check result display screen 5001, there are arranged an OK button 5004 used to show recognition of the results of operation check and terminate the check operation, and a re-check button 5003 used to give an instruction for executing re-check when “NG” is displayed in any operation check box 5002.

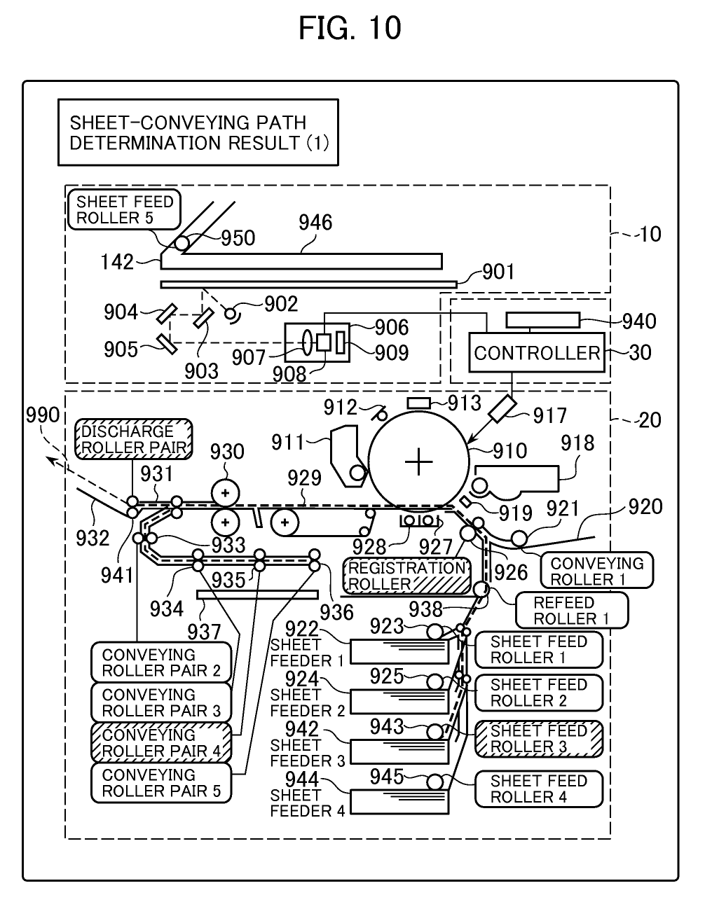

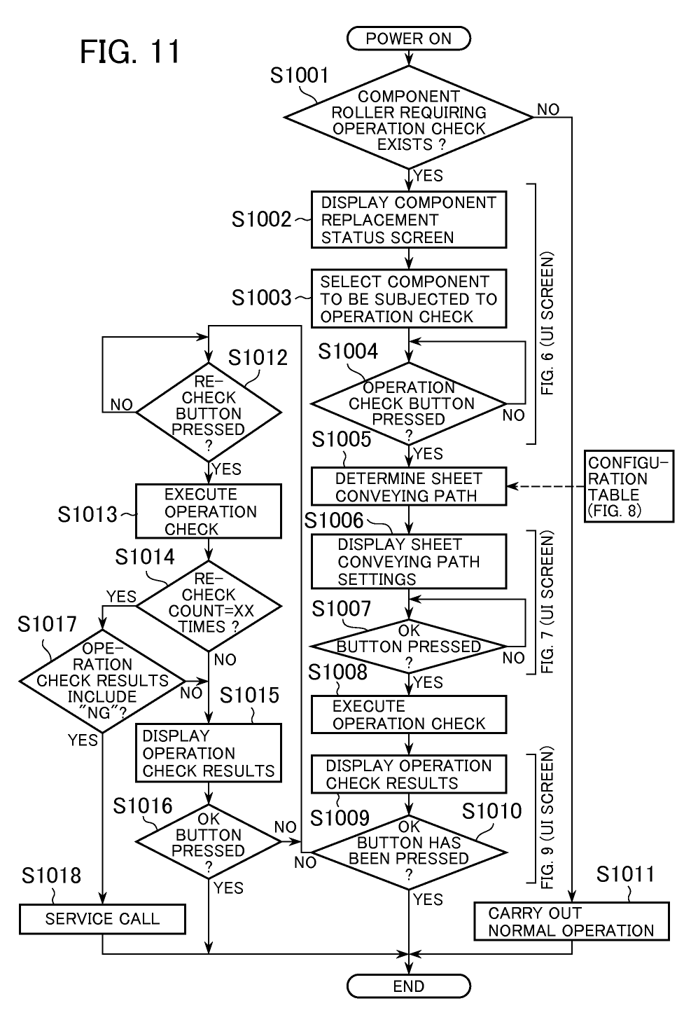

FIG. 10 is a schematic cross-sectional view of the image forming apparatus, in which a conveying path 990 determined for execution of a component roller check operation is indicated by a dotted line.

In FIG. 10, components corresponding to the component rollers selected for operation check using the associated checkboxes 3004 on the component replacement status screen 3001 in FIG. 6 are displayed in a shaded manner, and the conveying path 990 is configured such that a sheet passes these component rollers.

The cross-sectional view of the image forming apparatus in which the conveying path 990 is shown as described above may be displayed on the liquid crystal operation panel 2301 in place of the operation check job configuration screen 4001 in FIG. 7.

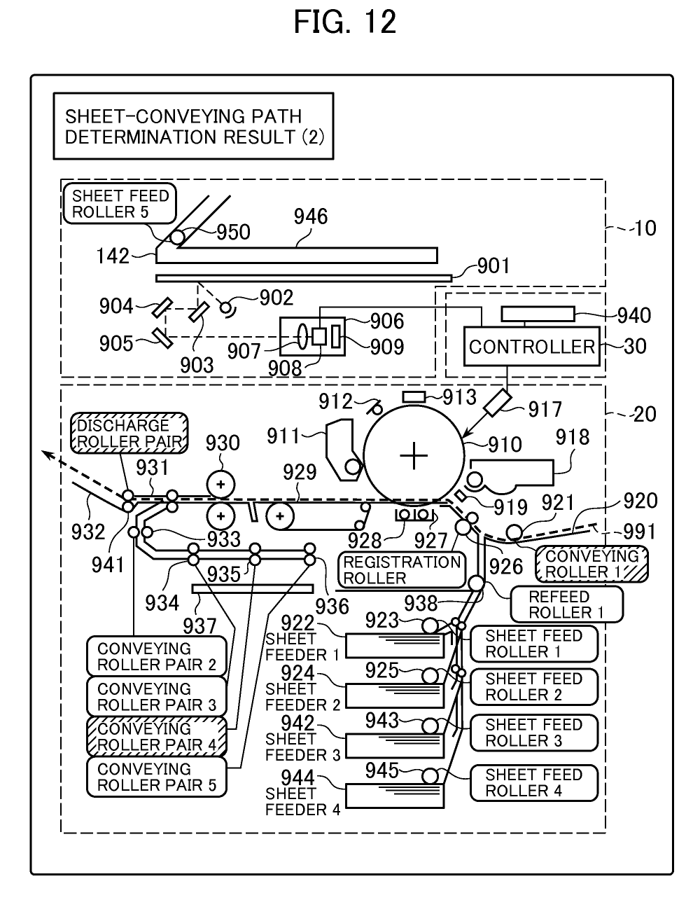

FIG. 12 is a schematic cross-sectional view of the image forming apparatus, in which a conveying path 991 determined so as to perform a check operation on different component rollers from the shaded ones in FIG. 10 is indicated by a dotted line.

In the present example, “conveying roller 1” and “discharge roller pair” are designated as targeted component rollers for operation check. In FIGS. 10 and 12, components are displayed by further adding reference numerals to related component names for ease of understanding of the description of the present embodiment.

Next, an operation check process executed by the image forming apparatus of the present embodiment will be described with reference to FIG. 11. In the operation check process of the present embodiment, a conveying path to pass the component rollers to be subjected to operation check is automatically set. The operation check process in FIG. 11 is executed by the CPU 1201 based on the control program loaded into the RAM 1202 from a storage unit (i.e. the ROM 1203 or the HDD 1204).

First, in a step S1001, the CPU 1201 determines whether or not there is a component roller requiring operation check. In the present embodiment, the determination is performed based on a signal (detection result) from a replacement detecting unit, not shown, for detecting component roller replacement.

Alternatively or additionally, the user may designate a component roller requiring operation check via the operating section 140 to cause the CPU 1201 to determine, based on the input information, that the component roller requires operation check.

If the CPU 1201 determines that there is a component roller requiring operation check, the process proceeds to a step S1002, whereas if not, the process proceeds to a step S1011, wherein a normal image forming operation is carried out.

In the step S1002, based on the determination in the step S1001 that there is a component roller requiring operation check, the CPU 1201 controls the operating section interface 1206 to display the component replacement status screen 3001 (see FIG. 6) on the liquid crystal operation panel 2301. On the component replacement status screen 3001 are displayed a list of component rollers requiring operation check, and the above-mentioned elements, etc. as described above.

Next, in a step S1003, the CPU 1201 accepts selection of component rollers requiring operation check from the list displayed on the component replacement status screen 3001. The selection of the component rollers is performed by the user who checks ones to be selected of the checkboxes 3004 provided on the component replacement status screen 3001.

Then, in a step S1004, the CPU 1201 determines whether or not the operation check button 3005 on the component replacement status screen 3001 has been pressed. If the operation check button 3005 has been pressed, the CPU 1201 judges that component rollers requiring operation check have been designated, and the process proceeds to a step S1005.

In the step S1005, the CPU 1201 reads out settings associated with the component rollers which are determined in the step S1004, by referring to information in the configuration table shown in FIG. 8, and determines a conveying path based on the read-out settings. Then, the process proceeds to a step S1006.

In the step S1006, the CPU 1201 controls the operating section interface 1206 to display the operation check job configuration screen 4001 shown in FIG. 7 on the liquid crystal operation panel 2301, and then the process proceeds to a step S1007.

In the step S1007, the CPU 1201 determines whether or not the OK button 4006 on the operation check job configuration screen 4001 has been pressed. If the OK button 4006 has been pressed, the process proceeds to a step S1008.

In the step S1008, the CPU 1201 controls a conveyance mechanism including the component rollers such that sheet feed, conveyance, and discharge are performed along the conveying path determined based on the operation check job settings determined in the step S1005.

At this time, the CPU 1201 detects sheet conveyance status, such as conveying timing and the number of times of retrial, via various sensors, not shown, arranged on the conveying path. Then, the CPU 1201 performs comparison between the results of the detection and associated threshold values to determine whether or not sheet conveyance has been normally performed. By doing this, the CPU 1201 checks the operations of the component rollers.

Next, in a step S1009, the CPU 1201 controls the operating section interface 1206 to display the operation check result display screen 5001 (see FIG. 9) showing the operation check results obtained in the step S1008 in association with the respective component rollers, on the liquid crystal operation panel (display section) 2301.

When the operation of a component roller is normal, “OK” is displayed in an associated one of the operation check fields 5002 on the operation check result display screen 5001, whereas when the operation of a component roller is not normal, “NG” is displayed in an associated one of the operation check fields 5002. Further, when the operation check results obtained in the step S1008 include at least one displayed as “NG”, i.e. when the operation of at least one component roller is not normal, the CPU 1201 controls the operating section interface 1206 to display the re-check button 5003 on the operation check result display screen 5001.

Then, in a step S1010, the CPU 1201 determines whether or not the OK button 5004 on the operation check result display screen 5001 has been pressed. If the OK button 5004 has been pressed, the process is terminated, whereas if not, the process proceeds to a step S1012.

In the step S1012, the CPU 1201 determines whether or not the re-check button 5003 has been pressed. If the re-check button 5003 has been pressed, the process proceeds to a step S1013.

In the step S1013, the CPU 1201 executes component roller operation check again under the same conditions as the settings configured for operation check in the step S1008, and then the process proceeds to a step S1014.

In the step S1014, the CPU 1201 determines whether or not the number of times of depression of the re-check button 5003 has reached a predetermined number. If the number of times of depression of the re-check button 5003 has not reached the predetermined number, the process proceeds to a step S1015, whereas if the number of times of depression of the re-check button 5003 has reached the predetermined number, the process proceeds to a step S1017.

In the step S1017, the CPU 1201 determines whether or not operation check results obtained in the step S1013 include at least one displayed as “NG”, i.e. whether or not the operation of at least one component roller is not normal. If the operation of at least one component roller is not normal, the process proceeds to a step S1018, whereas if the operations of all the component rollers are normal, the process proceeds to the step S1015.

In the step S1018, the CPU 1201 controls the operating section interface 1206 to display service call instructions e.g. on the liquid crystal operation panel 2301.

In the step S1015, the CPU 1201 controls the operating section interface 1206 to display the operation check result display screen 5001 (see FIG. 9) showing the operation check results obtained in the step S1013 on the liquid crystal operation panel 2301 similarly to the step S1009.

Further, when the operation check results obtained in the step S1013 include at least one displayed as “NG”, i.e. when the operation of at least one component roller is not normal, the CPU 1201 controls the operating section interface 1206 to display the re-check button 5003 on the operation check result display screen 5001.

Then, in a step S1016, the CPU 1201 determines whether or not the OK button 5004 on the operation check result display screen 5001 has been pressed. If the OK button 5004 has been pressed, the operation check process is terminated.

On the other hand, if the OK button 5004 has not been pressed on the operation check result display screen 5001, the process returns to the step S1012, and the same processing as described above is repeatedly carried out.

In the image forming apparatus of the present embodiment, when a plurality of component rollers targeted for operation check exist, it is sometimes impossible to perform operation check on all the component rollers via a single conveying path.

In this case, a plurality of conveying paths are set such that the number of sheets to be fed is minimized so as to suppress consumption of sheets.

For example, if all the component rollers described with reference to FIGS. 10 and 12 are simultaneously targeted for operation check, it is impossible to perform operation check on all the component rollers only by feeding a single sheet.

For this reason, when these component rollers are all simultaneously targeted for operation check, operation check is performed twice by dividing sheet feed operation into two such that one sheet is fed from the sheet feeder 3(942) and one sheet from the manual feed tray 920. Therefore, in this case, a total of two sheets is the minimum number of sheets to be fed.

For another example, in the conveying path 990 shown in FIG. 10, a conveying roller pair 4 and the discharge roller pair have been replaced with new ones, respectively.

In this case, a conveying path passing the discharge roller pair and a conveying path passing the conveying roller pair 4 are configured not as two independent paths, but as a single path. In other words, a conveying path is determined such that component roller operation check can be performed by feeding only one sheet.

As described above, according to the present embodiment, a conveying path to pass component rollers targeted for operation check is automatically configured, which enables the user to easily check the operation of each component roller even if the user is not well informed about the mechanism of the image forming apparatus. This makes it easy for the user to replace component rollers by him/herself.

It should be noted that the present invention is not limited to the above-described embodiment, but it can be practiced in various forms, without departing from the spirit and scope thereof.

For example, although in the above described embodiment, the present invention is applied to an electrophotographic image forming apparatus using a photosensitive drum and the like, the present invention may be applied to an inkjet image forming apparatus which directly prints an image on a sheet by jetting ink onto the sheet from an array of small nozzles.

Further, it is to be understood that the present invention may also be accomplished by supplying a system or an apparatus with a storage medium in which a program code of software, which realizes the functions of the above described embodiment, is stored, and causing a computer (or CPU or MPU) of the system or apparatus to read out and execute the program code stored in the storage medium.

In this case, the program code itself read from the storage medium realizes the functions of the above described embodiment, and therefore the program code and the storage medium in which the program code is stored constitute the present invention.

Examples of the storage medium for supplying the program code include a floppy (registered trademark) disk, a hard disk, a magnetic-optical disk, an optical disk, such as a CD-ROM, a CD-R, a CD-RW, a DVD-ROM, a DVD-RAM, a DVD-RW, or a DVD+RW, a magnetic tape, a nonvolatile memory card, and a ROM. Alternatively, the program may be downloaded via a network.

Further, it is to be understood that the functions of the above described embodiment may be accomplished not only by executing the program code read out by a computer, but also by causing an OS (operating system) or the like which operates on the computer to perform a part or all of the actual operations based on instructions of the program code.

Further, it is to be understood that the functions of the above described embodiment may be accomplished by writing a program code read out from the storage medium into a memory provided on an expansion board inserted into a computer or a memory provided in an expansion unit connected to the computer and then causing a CPU or the like provided in the expansion board or the expansion unit to perform a part or all of the actual operations based on instructions of the program code.

While the present invention has been described with reference to an exemplary embodiment, it is to be understood that the invention is not limited to the disclosed exemplary embodiment. The scope of the following claims is to be accorded the broadest interpretation so as to encompass all modifications, equivalent structures and functions.

This application claims priority from Japanese Patent Application No. 2008-067881 filed Mar. 17, 2008, which is hereby incorporated by reference herein in its entirety.

What is claimed is:

1. An image forming apparatus provided with a sheet conveying mechanism including a plurality of component rollers, comprising:
a selecting unit configured to select a component roller to be subjected to operation check from the component rollers;
a determining unit configured to determine a sheet conveying path passing the component roller selected by said selecting unit; and
a control unit configured to control the sheet conveying mechanism such that a sheet is conveyed along the conveying path determined by said determining unit.

2. The image forming apparatus according to claim 1, further comprising a detecting unit configured to detect a conveyance status of a sheet when the sheet is conveyed along the conveying path.

3. The image forming apparatus according to claim 2, comprising a check unit configured to check operation of the selected component roller based on the conveyance status detected by said detecting unit, and
a display unit configured to display a result of the operation check performed on the component roller by said check unit.

4. The image forming apparatus according to claim 1, comprising a sensor unit configured to sense replacement of the component roller, and
wherein said selecting unit selects the component roller replacement of which is sensed by said sensor unit, as a component roller to be subjected to operation check.

5. The image forming apparatus according to claim 1, comprising an operating section configured to enable a user to input an instruction for designating the component roller to be subjected to operation check, and
wherein said selecting unit selects the component roller designated via the operating section, as the component roller to be subjected to operation check.

6. The image forming apparatus according to claim 1, wherein when it is required to set a plurality of conveying paths, said determining unit configures the conveying paths such that a number of sheets to be fed is minimized.

7. The image forming apparatus according to claim 1, comprising a storage unit configured to store a configuration table showing relationships between the component rollers and settings for determining a conveying path for each of the component rollers, and
wherein said determining unit determines a sheet conveying path based on the configuration table stored in said storage unit.

8. A method of controlling an image forming apparatus provided with a sheet conveying mechanism including a plurality of component rollers, comprising:
selecting a component roller to be subjected to operation check from the component rollers;
determining a sheet conveying path to pass the selected component roller; and
controlling the sheet conveying mechanism such that a sheet is conveyed along the determined conveying path.

9. A computer-readable storage medium storing a program for causing a computer to execute a method of controlling an image forming apparatus provided with a sheet conveying mechanism including a plurality of component rollers,
wherein the method comprises:
selecting a component roller to be subjected to operation check from the component rollers;
determining a sheet conveying path to pass the selected component roller; and
controlling the sheet conveying mechanism such that a sheet is conveyed along the determined conveying path.
